(19) United States
(12) Patent Application Publication
(10) Pub. No.: US 2008/0030995 A1
(43) Pub. Date: Feb. 7, 2008

(54) Lamp shade structure

(76) Inventor: Tai-Shen Chen, Banchiau City (TW)

Correspondence Address: Troxell Law Office PLLC, Suite 1404, 5205 Leesburg Pike, Falls Church, VA, 22041, US

(21) Appl. No.: 11/730,353

(22) Filed: Mar. 30, 2007

(30) Foreign Application Priority Data
Mar. 31, 2006 (TW) 095205475

(51) Int. Cl. F21V 1/12

(52) U.S. Cl. 362/360

(57) ABSTRACT

A lamp shade structure refers to a design of a multi-layer shade. A top and a bottom end of the shade is provided respectively with a positioning ring, at least one layer of rigid member in a shape of mesh grids wraps around between the two positioning rings, and the positioning ring at the bottom end is connected inward with an assembly board to assemble a lamp. Each spaced mesh grid on the rigid member in the shape of mesh grids is enclosed by an enclosing member. When the shade is sheathed on the lamp, light released from a bulb will be transmitted out through the mesh grids that are spaced on the shade, thereby constituting an effect of explicit light scales.

### BACKGROUND OF THE INVENTION

(a) Field of the Invention

The present invention relates to a lamp shade structure, and more particularly to a multi-layer shade design that is related to a lamp shade, enabling light which is projected by the lamp to manifest an effect of explicit light scales, through installation of the shade.

(b) Description of the Prior Art

For an ordinary lamp, especially a desk lamp, a table lamp, a street lamp, or a decoration lamp, an exterior side of the lamp is usually added with a lamp shade to increase a visual sense and provide a better value-added in use.

Light which is projected by the lamp can be changed to manifest a different variation through installation of the lamp shade. However, for most of the lamp shades, change of color of the lamp shade is primarily used, in association with through-holes which are disposed on a refraction board in an interior of the lamp shade, to allow that after light is projected out through the through-holes, a visual sense of the entire lamp is enhanced with the color of the shade itself, thereby attracting a consumer.

As each vendor will use this same approach to proceed with designing the lamp, all of the lamps on the market are similar without being able to make a breakthrough, thereby resulting in an unsalable phenomenon to the selling of lamps. Therefore, how to provide a brand new lamp shade and to improve a value-added of the lamp is a technical issue to be solved by the present invention.

### SUMMARY OF THE INVENTION

The primary object of present invention is to provide a lamp shade structure, wherein top and bottom ends of the shade are provided respectively with a positioning ring, at least a layer of rigid member in a shape of mesh grids wraps around between the two positioning rings, the bottom positioning ring is connected inward with an assembly board for assembling the lamp, and each mesh grid which is spaced on the rigid member in the shape of mesh grids is enclosed by an enclosing member, such that when the shade is sheathed on the lamp, light released from a lamp bulb will be transmitted out through the mesh grids that are spaced on the rigid member, thereby constituting an effect of explicit light scales.

An enclosing member is also used to enclose a part between the two positioning rings, so as to manifest a double transmission effect through the enclosing member that is located between the positioning rings and the enclosing member that is spaced on the rigid member, thereby increasing an effect of variation of light upon being projected out.

On the other hand, two layers of the rigid member can be also disposed between the positioning rings, and the mesh grids on the two rigid members can be also configured in spacing, such that when the enclosing members enclose respectively on the different layers of rigid members, the enclosing members can manifest an alignment of alternate spacing, and can also manifest different variations of the light.

In addition, the enclosing members can be also used with different colors, such that when they enclose on the rigid members, the rigid members can manifest change of different colors, thereby manifesting the change of different colors after the light is projected outward from the enclosing members.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a first embodient of the present invention.

FIG. 2 shows a schematic view of a first embodient of the present invention that is not provided with an enclosing member.

FIG. 3 shows a schematic view of a first embodient of the present invention, wherein a first rigid member is installed with an enclosing member.

FIG. 4 shows a schematic view of a second embodient of the present invention.

FIG. 5 shows a schematic view of a second embodient of the present invention, wherein a first layer of enclosing member is installed.

FIG. 6 shows a schematic view a second embodient of the present invention, wherein a second layer of enclosing member is installed.

FIG. 7 shows an exploded view of a second embodient of the present invention.

### DETAILED DESCRIPTION OF THE PREFERRED EMBODIMENTS

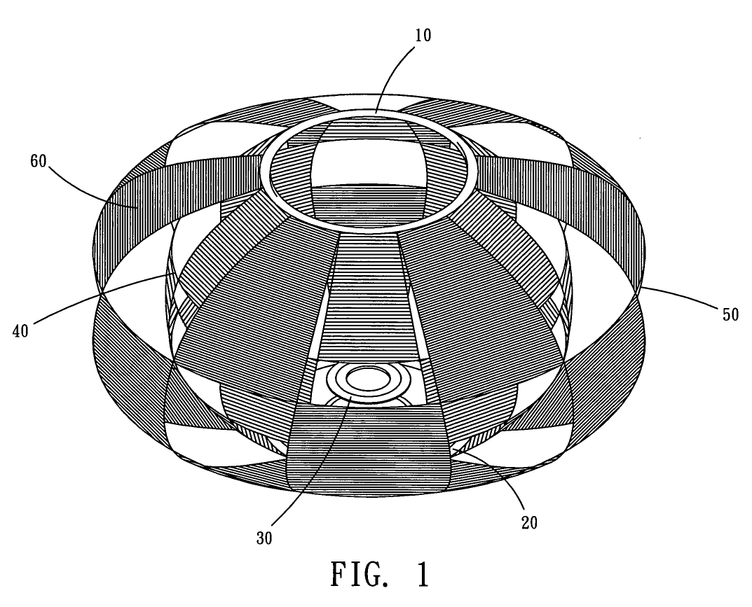

Referring to FIG. 1, a lamp shade structure of the present invention includes primarily two positioning rings, which are divided into a first positioning ring 10 and a second positioning ring 20 being located respectively on a top and a bottom end, and can be in a ring shape, a polyhedral shape, or a square shape, whereas in this embodiment, the ring shape; an assembly board 30, which is connected on the second positioning ring 20 at the bottom end to provide for an assembly of the lamp; at least one layer of a rigid member in a shape of mesh grids, which is connected between the first positioning ring 10 and the second positioning ring 20 in a ring, and is configured as two layers of the rigid members in this embodient, including a first rigid member 40 and a second rigid member 50; and a plurality of enclosing members 60 which enclose on the mesh grids of the first rigid member 40 and the second rigid member 50, being aligned with intervals.

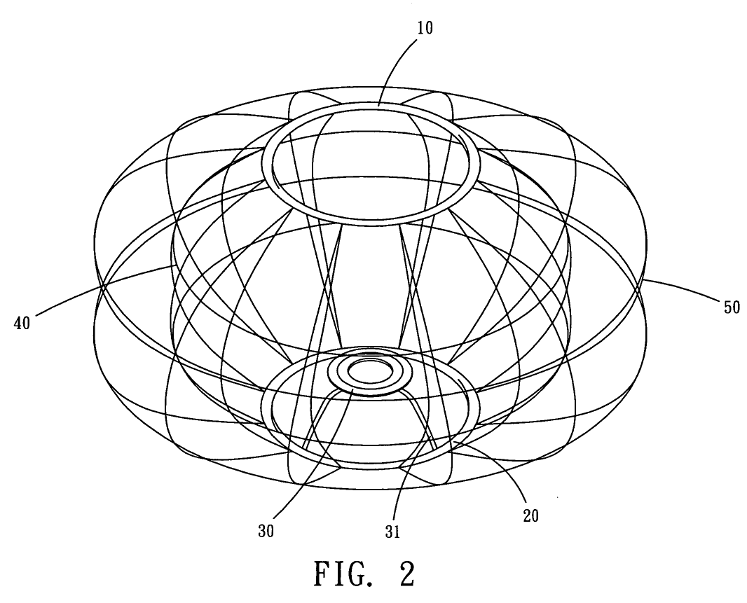

Referring to FIG. 2, it shows a schematic view wherein the enclosing members do not enclose on the rigid members. The first rigid member 40 and the second rigid member 50 wrap around between the first positioning ring 10 and the second positioning ring 20, and the second rigid member 50 is disposed at an exterior side of the first rigid member 40; whereas both the first rigid member 40 and the second rigid member 50 are provided with mesh grids that are aligned with intervals. The assembly board 30 is connected on the second positioning ring 20 by a plurality of pins 31, and is located at a position roughly above a center of the second positioning ring 20.

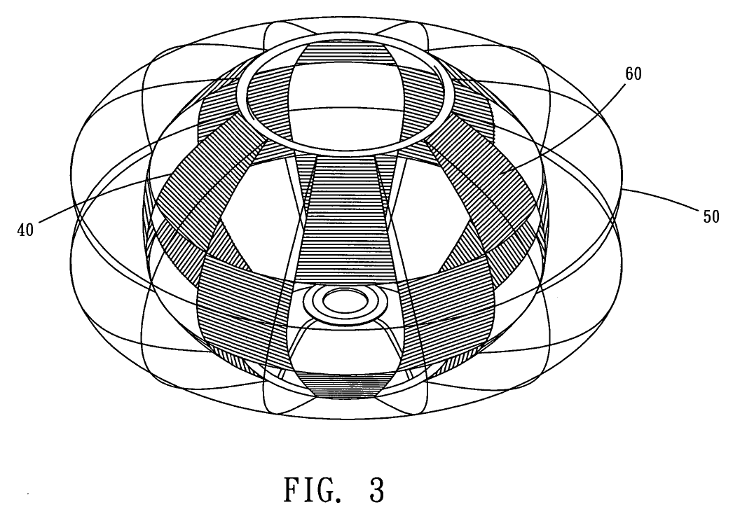

Referring to FIG. 3, the enclosing members 60 first enclose on the mesh grids of the first rigid member 40 with an alignment in spacing. In this embodiment, they are installed one by one on the mesh grids with a rope, enabling the mesh grids to form slits in intervals. However, when the enclosing members 60 enclose on the mesh grids, the enclosing members 60 of different colors can be used to enclose on the mesh grids, enabling the first rigid member 40 to manifest a configuration of different colors.

After the mesh grids of the rigid member 40 are enclosed one by one with the enclosing members 60, the enclosing members 60 are used to enclose on the mesh grids of the second rigid member 50, with the same alignment in intervals, as shown in FIG. 1, which allows the enclosing members 60 that enclose the rigid member 40 and the second rigid member 50 to manifest the alignment in intervals.

Accordingly, when the shade is sheathed on a lamp (to be described hereafter), light released from the lamp can be projected out through the enclosing members 60 on the first rigid member 40 and the second rigid member 50, thereby manifesting an effect of explicit light scales. In the same time, by change of colors of the enclosing members 60, color of the light that is projected on the exterior side of the shade can be changed.

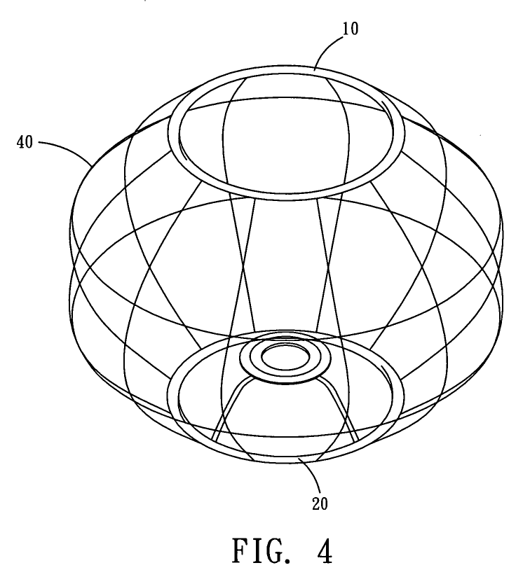

On the other hand, referring to FIG. 4, it shows a second embodiment of the present invention. A first rigid member 40 is provided between the first positioning ring 10 and the second positioning ring 20, and the first rigid member 40 is also provided with mesh grids that are aligned with intervals.

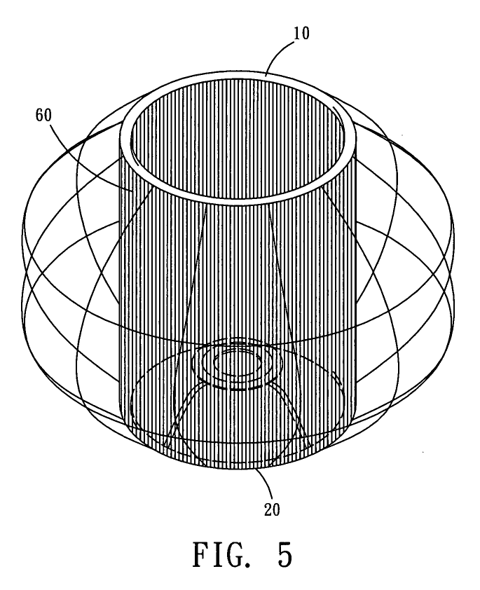

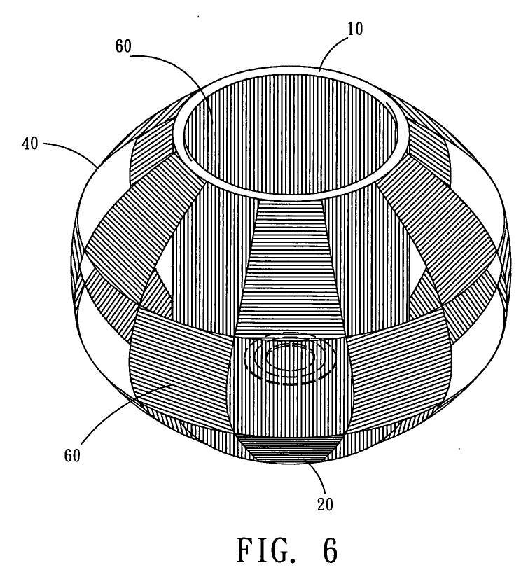

Referring to FIG. 5 and FIG. 6, in the second embodiment, the enclosing members 60 first enclose and wrap around one by one between the first positioning ring 10 and the second positioning ring 20 with a rope, forming vertical slits between the first positioning ring 10 and the second positioning ring 20, through the enclosure of the enclosing members 60.

Next, the enclosing members 60 enclose on the mesh grids of the first rigid member 40 in spacing, enabling the enclosing members 60 that are aligned with intervals on the first rigid member 40, and the enclosing members 60 that are located between the first positioning ring 10 and the second positioning ring 20 to manifest an effect of spacing in double layers.

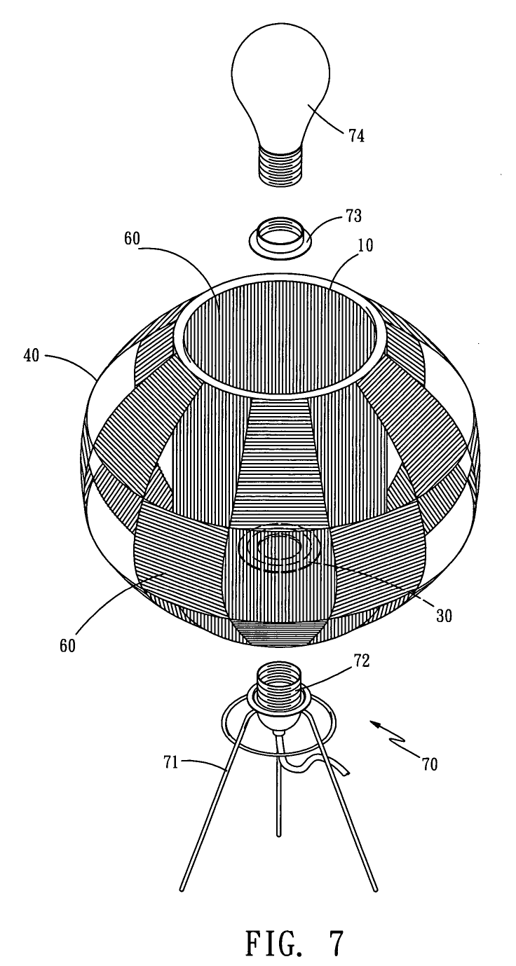

Referring to FIG. 7, it shows an exploded view of the second embodiment which is installed on a lamp. The lamp 70 includes a stand 71, a bulb seat 72, a positioning lock piece 73, and a bulb 74. In using the embodiment, the bulb seat 72 is fixed on the stand 71, and is then passed through a lower part of the assembly board 30 to fix the positioning lock piece 73 above the assembly board 30, such that the assembly board 30 is confined at the bulb seat 72 and the positioning lock piece 73. Finally, the bulb 74 is assembled on the bulb seat 72.

After the bulb seat 72 is conducted with a power source, light is released from the bulb 74. Whereas, after the light is released from the bulb 74, the light first transmits through the enclosing members 60 between the first positioning ring 10 and the second positioning ring 20 (as shown in FIG. 6), and is then projected out. In the same time, after the light is projected out, a part of the light is again stopped by the enclosing members 60 on the first rigid member 40, whereas the other part of the light directly passes through the mesh grids that are not enclosed by the enclosing members 60, thereby manifesting an effect of explicit light scales on the exterior side of the shade, after the light is projected out.

After employing the shade of the present invention by a user, a different change can be resulted to the light; in addition to that the spacing of the enclosing members 60 is changed, the color of enclosing members 60 is also changed, thereby changing the color of light when it is projected out, which increases a versatility in using the lamp.

As the rigid member can be in a circular shape, an elliptic shape, a square shape, a polyhedral shape, or an irregular shape, and can have a change in multiple layers, in association with the change of enclosing members and their colors, the effect and interest of the lamp is further increased.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A lamp shade structure comprising two positioning rings, which are disposed respectively at a top and a bottom end; an assembly board, which is connected on the positioning ring at the bottom end; at least one layer of rigid member in a shape of mesh grids, which is connected between the two positioning rings in a ring; and a plurality of enclosing members, which enclose on the mesh grids of rigid member in an alignment in spacing.

2. The lamp shade structure according to claim 1, wherein the enclosing members further wrap around between the two positioning rings.

3. The lamp shade structure according to claim 1, wherein the positioning rings are in a ring shape or a polyhedral shape.

4. The lamp shade structure according to claim 1, wherein the rigid members are in a circular shape, an elliptic shape, a polygonal shape, or an irregular shape.
